(19) United States
(12) Patent Application Publication
(10) Pub. No.: US 2010/0057722 A1
(43) Pub. Date: Mar. 4, 2010

(54) Image processing apparatus, method, and computer program product

(75) Inventors: Norihiro Nakamura, Kanagawa (JP); Yasukazu Higuchi, Kanagawa (JP); Masahiro Sekine, Tokyo (JP); Isao Mihara, Tokyo (JP); Yasunobu Yamauchi, Tokyo (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/461,761

(22) Filed: Aug. 24, 2009

(30) Foreign Application Priority Data
Aug. 28, 2008 (JP) 2008-220507

(51) Int. Cl. G06F 7/10; G06F 17/30

(52) U.S. Cl. 707/5; 707/E17.03; 707/E17.109

(57) ABSTRACT

The target content selecting unit selects a first image from the content storage unit. The relevance calculating unit calculates relevance of second images to the first image by use of the metadata. The display content selecting unit identifies a second image selected before the first image, based on the history information, and selects the identified second image and any second images that satisfy a selection condition regarding the relevance. The output information generating unit generates output information that is used for displaying first selection information from which the first image can be selected and second selection information from which second images can be selected, on the display device. In this output information, the second selection information of second images having greater relevance is displayed closer to the first selection information.

### CROSS-REFERENCE TO RELATED APPLICATIONS

This application is based upon and claims the benefit of priority from the prior Japanese Patent Application No. 2008-220507, filed on Aug. 28, 2008; the entire contents of which are incorporated herein by reference.

### BACKGROUND OF THE INVENTION

1. Field of the Invention

The present invention relates to an apparatus, a method, and a computer program product for generating information used for displaying an image selected from multiple images together with other relevant images.

2. Description of the Related Art

The search function of a PC has been widely used in everyday jobs. For example, web searches offered by web service providers have been widely and universally used. In general, when a search is conducted on a PC, the user actively executes the search by inputting as a search keyword what the user desires to search for.

Nowadays, information technology has been developed into the field of audiovisual apparatus such as television sets, DVD recorders, and HDD recorders, which can now be connected to the Internet. In accordance with this development, the AV apparatus is provided with a search function similar to that of the PCs. Similarly to the function of the PCs, the search function offered for the AV apparatus is an active search function.

Meanwhile, the content storing capacity of the AV apparatus, services such as video on demand (VOD), seamlessness of the contents within a device and also from other AV devices, and seamlessness of the contents from the Internet have been improved. For these reasons, the number of contents that are accessible for users has been rapidly and enormously increasing.

Furthermore, the users' content capturing and viewing styles have been changed due to the widespread HDD recorders. In particular, the active recording style in which the user selects and records desired contents only has been changing to a recording style in which the user records whatever seems to be interesting and chooses anything desired from the recorded data or a passive recording style in which a recommendation service or recording arrangement service is adopted. In accordance with such a change to the passive recording style, recent users do not always know all the contents that are accessible for them.

Under such circumstances, how the user can find contents that they desire from among an abundance of contents that are accessible from a device is a key point. For example, the user does not always know about all of the abundant accessible contents. For this reason, the user may not think of a suitable keyword when conducting a search by use of the active search function. It means that, with an AV device, it is difficult to find desired contents with the conventional active search function.

Furthermore, not all the AV-apparatus users are conversant with the PC operations. In other words, not all the AV-apparatus users are familiar with active searches of a keyword input style, which is conducted commonly in the field of PCs. In such a situation, the active search function is employed only by part of the AV-apparatus users, and is not really commonly used.

As a solution for the above situation, a passive search function may be offered, with which, unlike with the active search function, contents that the user probably likes are automatically searched for in accordance with the user's situation, and with which the display of search results has been improved so that the user can intuitively understand the results. For example, a method may be such that contents relevant to a certain content are searched for and displayed, from which the user can select a desired content. With this method, the user does not actively search for contents that the user wants to view by use of a keyword or the like. The relevance of contents that are searched for on the basis of a certain content is displayed so that the user implicitly conducts a content search. Thus, the user can find contents of interest, without any explicit search.

With such a passive content search method, it is essential to render the relevance of contents and present it to the user. The user selects a content from the contents that are passively searched for by referring to the rendered relevance and thereby finds a desired content out of massive contents accessible from the device.

In the field of photographs, a technology of rendering large amounts of photographs taken by a digital camera or the like has been developed. For example, International Publication WO 00/33572 discloses a technique of rendering large amounts of photographs in a space. With this technique, multiple images are sequentially enlarged in chronological order to show the chronological relevance of the images, and the enlarged images are displayed outwardly in a spiral form in chronological order. This makes it easy to understand the anteroposterior relation of the images in a chronological sequence.

According to the method of WO 00/33572, however, images are only chronologically displayed, and it is not aimed at a technology of suitably searching for and displaying relevant contents.

### SUMMARY OF THE INVENTION

According to one aspect of the present invention, an image processing apparatus includes an image processing apparatus comprising: an image storage unit that stores a plurality of images and metadata of the images; a first selecting unit that sequentially selects a first image, which is any one of the images stored in the image storage unit; a selection history storage unit that stores history information capable of identifying images selected by the first selecting unit past and an order in which the images are selected; a relevance calculating unit that calculates a relevance representing how relevant the first image is to the images other than the first image, based on metadata of the first image and metadata of images stored in the image storage unit other than the first image; a second selecting unit that selects, based on the history information, second images representing at least an image selected immediately before the first image and an image that satisfies a first selection condition predetermined in relation to the relevance; and a generating unit that generates output information, which is information for displaying, on a display device, first selection information capable of selecting the first image and second selection information capable of selecting any of the second images, the second selection information of the second images having greater relevance being displayed closer to the first selection information.

According to another aspect of the present invention, an image processing method includes sequentially selecting from a plurality of images stored in an image storage unit that stores the images and metadata of the images, a first image that is any one of the images; storing in a selection history storage unit history information capable of identifying the images which are selected past and an order in which the images are selected; calculating a relevance representing how relevant the first image is to the images other than the first image, based on metadata of the first image and metadata of images other than the first image among the images stored in the image storage unit; selecting, based on the history information, second images representing at least an image selected immediately before the first image and an image that satisfies a first selection condition predetermined in relation to the relevance; and generating output information, which is information for displaying, on a display device, first selection information capable of selecting the first image and second selection information capable of selecting any of the second images, the second selection information of second images having greater relevance being displayed closer to the first selection information.

A computer program product according to still another aspect of the present invention causes a computer to perform the method according to the present invention.

### BRIEF DESCRIPTION OF THE DRAWINGS

FIG. 1 is a block diagram for illustrating a structure of an image processing apparatus according to a first embodiment;

FIG. 2 is a diagram for illustrating an example data structure of data stored in a content storage unit;

FIG. 3 is a diagram for illustrating an example data structure of history information stored in a selection history storage unit;

FIG. 4 is a diagram for illustrating an example of a rendered display content;

FIG. 5 is a diagram for illustrating an example of rendered contents arranged in a three-dimensional space;

FIG. 6 is a diagram for illustrating another example arrangement of rendered contents viewed from a direction different from FIG. 5;

FIG. 7 is a flowchart of the entire image processing according to the first embodiment;

FIG. 8 is a flowchart of a display content selecting process according to the first embodiment;

FIG. 9 is a flowchart of an output information generating process according to the first embodiment;

FIG. 10 is a schematic diagram for illustrating an example arrangement of rendered contents in a three-dimensional space;

FIG. 11 is a schematic diagram for illustrating another example arrangement of rendered contents in the three-dimensional space;

FIG. 12 is a flowchart for illustrating an output information generating process according to a modification example of the first embodiment;

FIG. 13 is a block diagram for illustrating a structure of an image processing apparatus according to a second embodiment; and

FIG. 14 is a diagram for explaining the hardware structure of the image processing apparatus according to the first or second embodiment.

### DETAILED DESCRIPTION OF THE INVENTION

Exemplary embodiments of an apparatus, a method, and a computer program product according to the present invention are explained in detail below with reference to the attached drawings.

An image processing apparatus according to a first embodiment of the present invention calculates relevance of contents other than chronological relevance by use of specific information regarding the contents, and thereby selects contents that have great relevance more suitably than a comparative example of displaying candidates of contents in which the user may show interest.

In the comparative example, information attached to the content selected by the user, for example, is referred to, and the relevance of the corresponding information of other contents is calculated. Contents having great relevance are obtained and presented to the user. When the user further selects any of the presented relevant contents, contents relevant to the selected relevant content are further searched for and displayed. Usually, when a relevant content displayed in relation to a certain content is selected, this original content is displayed as a relevant content for the selected relevant content. In this manner, the user can select a different relevant content by returning to the original content.

With some relevance calculation methods, however, the original content is not always found as a relevant content so that the user cannot return to the original content. For example, when the relevance is calculated based on the information attached to the selected content in comparison with the corresponding information of other contents, the relevance value for a pair of contents may differ, depending on which of the two contents are used as a reference. As a result, if the relevance value of the original content becomes smaller than the relevance values of other contents, the original content may not be displayed as a relevant content due to the limit on the number of displayable contents.

As a result, the user may not be able to accurately learn the relevance of the sequentially selected contents and select a desired content.

In contrast, the image processing apparatus according to the first embodiment stores therein the history of selected contents, and selects the previously selected contents as contents relevant to a selected content by referring to the stored history. As a result, the user is allowed to return to the content selected immediately before, and suitably select the relevant content.

An image processing apparatus 100 according to the first embodiment may be realized as an HDD recorder that records moving image contents such as TV programs and movies. An applicable device is not limited to the HDD recorder. In addition, a target content is not limited to a moving image content, but may be a still image content. In the example in the following explanation, a moving image content is mainly dealt with as a processing target.

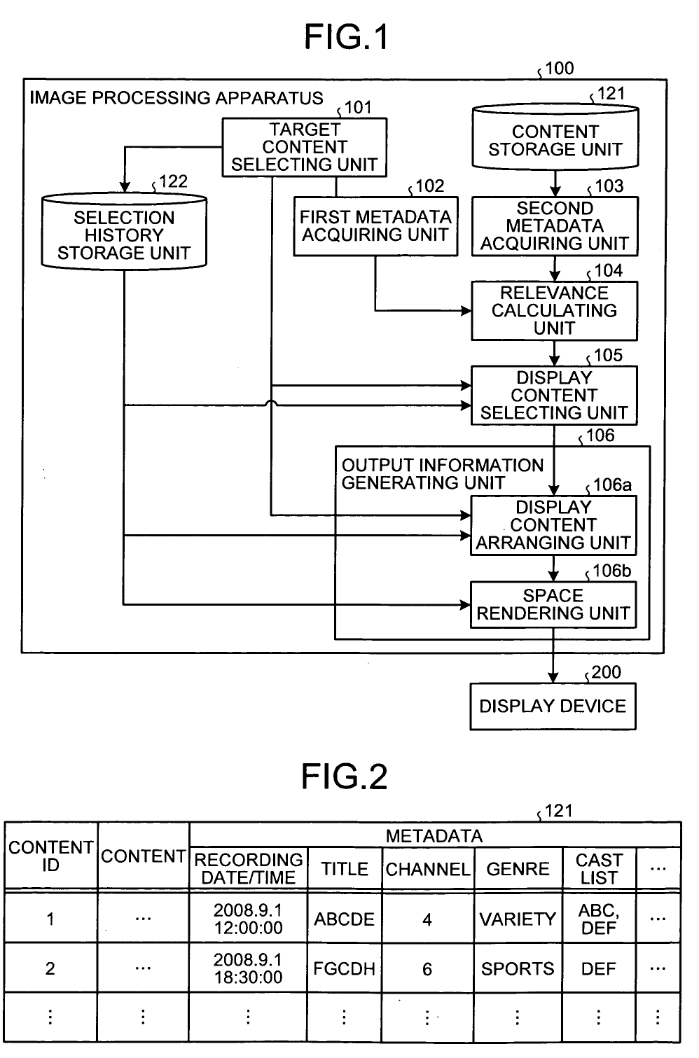

As illustrated in FIG. 1, the image processing apparatus 100 includes a content storage unit 121, a selection history storage unit 122, a target content selecting unit 101, a first metadata acquiring unit 102, a second metadata acquiring unit 103, a relevance calculating unit 104, a display content selecting unit 105, and an output information generating unit 106.

The content storage unit 121 stores therein moving image content data and metadata that is information attached to the moving image content data. For example, when the image processing apparatus 100 is realized as an HDD recorder, the content storage unit 121 corresponds to a database for recording TV programs as moving image contents in specific areas of the HDD and retrieving the recorded contents. The content storage unit 121 stores therein a group of moving image contents that the user has recorded. The user retrieves a desired moving image content from the content storage unit 121 and views the content.

As illustrated in FIG. 2, the content storage unit 121 stores therein data of content IDs that identify the contents, actual data of the contents, and data metadata of the contents in association with one another.

The storage form of the actual data of contents is not particularly limited. For example, contents such as TV programs are stored as files encoded by use of a codec such as MPEG2 and H.264. The actual data may be stored in a different storage unit in association with the content IDs.

As metadata, information acquired from, for example, EPG that is attached to a moving image content of a TV program is stored. The EPG is an electronic program listing data available by way of the Internet or data broadcasting. The EPG includes various kinds of information on the broadcasting date/time, broadcast channel, title, subtitle, outline, genre, cast members, producers, and the like of the TV program. The content storage unit 121 stores therein the information acquired from the EPG, as metadata, in association with each content.

In addition, the metadata includes the date/time and conditions of recording the moving image content in the content storage unit 121. When the image processing apparatus 100 records the content, the metadata is changed to tag information by referring to the EPG or the like, and attached to the actual data of the moving image content to be stored in the content storage unit 121.

With a VOD service or a moving image sharing service on the network, the actual data of a moving image content with the above metadata embedded as tag information of the actual data may be distributed from a service provider to the image processing apparatus 100 such as an HDD recorder by way of a network circuit, and stored in the content storage unit 121.

In FIG. 2, an example of storing as metadata a list of recording date/time, title of the content, channel, genre, and cast members is presented. The information stored as metadata is not limited thereto, however. For example, the device may be configured in such a manner that information input by the user may be stored as metadata.

Moreover, the moving image content is not limited to TV programs, and the metadata is not limited to the information obtained from the EPG. The content storage unit 121 is not limited to the HDD, but may be configured by any recording medium that is generally used such as a DVD-RAM, an optical disk, and a memory card.

Furthermore, the area of the content storage unit 121 for storing the acquired data is not limited to a single area, but may be spanned to the HDD and the DVD-RAM. If the data can be retrieved from a database system or the like by a specific retrieving process, the data may be stored in multiple areas. In other words, the data can be separated into multiple areas as long as the desired data is accessible by a single operation, in the same manner as accessing the data stored in a single area. The area for storing data does not always have to be provided within the image processing apparatus 100. For example, the system may be configured in such a manner that the data can be stored and retrieved by accessing a separate HDD or the like that is connected by way of a network.

The selection history storage unit 122 stores therein history information for identifying a content selected past as the process target content by the target content selecting unit 101 from the contents stored in the content storage unit 121, which will be described later, and the order of selection. For example, the selection history storage unit 122 stores therein content IDs of selected contents in the order of selection.

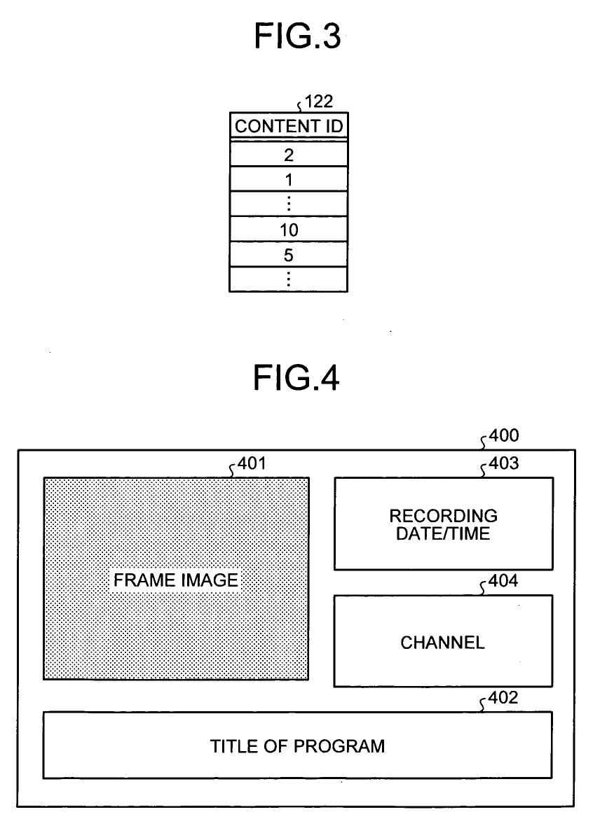

The process target content denotes a content that serves as a reference in a search of relevant contents. The selection history storage unit 122 stores therein content IDs of contents that are previously selected as process target contents, chronologically in the order in which they are selected. As indicated in FIG. 3, the history information includes content IDs.

The history information is not limited to the above form, however. The history information can be in any form as long as the selected contents and the order of selection are identifiable. In addition, the data stored in the selection history storage unit 122 is not limited to the above, and the metadata acquired from the content storage unit 121, such as titles and outlines of the programs, may be stored together.

A limit may be placed on the number of contents stored in the selection history storage unit 122 (the number of stored contents). The number of stored contents may be determined in accordance with the initial setting of the system or changes of the setting instructed by the user. If the number of stored contents is N (an integer equal to or greater than 1), the history information of a previously stored content, such as the history information of the oldest content stored at the first time, is deleted from the selection history storage unit 122 at the same time of storing the history information of the N+1-th process target content so that the number of stored contents can be adjusted.

The selected contents do not always have to be stored. For example, the method may be such that, when a content is selected to be stored, whether the history information of the selected content is already stored in the selection history storage unit 122 is determined. When it is not stored, this history information may be added. In this manner, two items or more of the history information for the same content would not be included in the selection history storage unit 122, and the previously stored history information item is stored on a priority basis.

In contrast, the method may be such that, when the history information of the selected content is already stored in the selection history storage unit 122, the history information of the selected content is added while the stored history information is deleted. Then, the history information of the newly selected content is preferentially stored. In the following description, a content whose history information is stored in the selection history storage unit 122 is referred to as a “history content”.

The target content selecting unit 101 selects, as a process target content, a moving image content that satisfies specific selection conditions from the content storage unit 121. The selection conditions may be such that the content that is being viewed is selected as a process target content, and if no content is being viewed, the last viewed content is selected as a process target content.

Alternately, the selection conditions may be such that a content having the greatest relevance (later explained) to the current process target content is selected as the next process target content at established intervals. A condition that the process target content should be of the same genre may be included in the selection conditions.

Furthermore, a selection condition may be such that a content selected by the user with a graphical user interface (GUI) of a display device 200 on its display screen is adopted for a process target content. For example, a content selected by the user with a remote controller or the like from a list of recorded contents displayed on the display screen of the display device 200 may be selected as a process target content.

Moreover, a selection condition may be such that a content is selected in accordance with the user's preference by referring to the preliminarily prepared user profile in the same manner as the recommendation service and the recording arrangement service. For example, the user may designate “soccer programs” as desired contents in the user profile. Then, the target content selecting unit 101 refers to the designated information and selects a content that meets “soccer programs” as a process target content from the content storage unit 121.

A selection condition that a program most frequently browsed by the user is selected by referring to the user's operation history that is pre-stored may be adopted. Any selection conditions can be used as long as a specific content can be selected from the contents stored in the content storage unit 121.

The first metadata acquiring unit 102 acquires the metadata of the process target content selected by the target content selecting unit 101 from the content storage unit 121. When the acquired metadata does not include image information representing the content (hereinafter, “content representing image”), the first metadata acquiring unit 102 generates a content representing image. The first metadata acquiring unit 102 generates, for example, the leading frame of the moving image content as a content representing image. The method of generating a content representing image is not limited thereto, however. For example, a frame detected by cut detection may be adopted for the content representing image.

The second metadata acquiring unit 103 acquires the metadata of the designated moving image content from the content storage unit 121 in accordance with an instruction issued by the relevance calculating unit 104, which will be explained later. More specifically, the second metadata acquiring unit 103 acquires, from the content storage unit 121, the metadata of contents other than the process target content selected by the target content selecting unit 101. The acquired metadata is referred to when the relevance calculating unit 104 calculates the relevance of the contents.

Further, when the acquired metadata does not include a content representing image, the second metadata acquiring unit 103 generates the content representing image of the process target content in a similar manner to the first metadata acquiring unit 102.

The relevance calculating unit 104 calculates the relevance representing the degree of relevance of the process target and other contents on the basis of the metadata of the process target content acquired by the first metadata acquiring unit 102 and the metadata of each of other contents acquired by the second metadata acquiring unit 103.

First, the relevance calculating unit 104 determines the process target content as a target content for the relevance calculation (calculation target content 1). Then, the relevance calculating unit 104 acquires the metadata of the calculation target content 1 (hereinafter, “metadata 1”) from the first metadata acquiring unit 102.

Next, the relevance calculating unit 104 determines a single content other than the process target content as a target content for the relevance calculation (calculation target content 2). Then, the relevance calculating unit 104 acquires the metadata of the calculation target content 2 (hereinafter, “metadata 2”) from the second metadata acquiring unit 103. The structure may be such that the display content selecting unit 105, which will be described later, determines the calculation target content 2 and issues an instruction of calculating the relevance to the relevance calculating unit 104.

As a result, information such as the recording date/time, recording conditions, title, subtitle, broadcasting date/time, broadcast channel, genre, outline/details, cast list, description, producer for each of the calculation target contents 1 and 2 can be acquired as the metadata 1 and 2, respectively.

Then, the relevance calculating unit 104 compares the metadata 1 with the metadata 2 to find the relevance of the calculation target content 1 (process target content) and the calculation target content 2.

The relevance calculating unit 104 uses the following expression (1) for the relevance calculation.

$$Re lebance = {\sum }_{n = 1}^{N} {f}_{n} ( metadata 1 ( n ) , metadata 2 ( n ) ) \times {w}_{n} \qquad ( 1 )$$

In this expression, N represents the total number of metadata categories stored in the content storage unit 121. The metadata (n) represents the n-th metadata (n=1, . . . , N) of multiple categories of the metadata stored in the content storage unit 121, and yₙ=fₙ(x1ₙ, x2ₙ) represents a function that returns the relevance yₙ of metadata x1ₙ and metadata x2ₙ. The value of wₙ is a weight.

Although the metadata may include various categories as discussed above, in the following description, it is assumed for the sake of simplicity that the content storage unit 121 stores therein five categories of metadata; recording date/time, title, broadcast channel, genre, and cast list.

With such metadata, the relevance is expressed by the weighted linear sum of:
y₁=f₁ (recording date/time of metadata 1 and metadata 2)
y₂=f₂ (titles of metadata 1 and metadata 2)
y₃=f₃ (broadcast channels of metadata 1 and metadata 2)
y₄=f₄ (genres of metadata 1 and metadata 2)
y₅=f₅ (cast lists of metadata 1 and metadata 2)

Specific examples of f₁ to f₅ are explained below.

For example, f₁ takes a larger value as the recording dates/times are closer to each other, and a smaller value as they are more distant from each other. In particular, f₁=CO1/|diff(rec_date(metadata 1)−rec_date(metadata 2))| may be adopted. In this expression, rec_date(x) is a function that converts the recording date/time of the metadata x uniquely to an integer. For example, the function may change the recording time and date to an integer by setting a certain reference date/time to 0 and counting seconds elapsed from the reference date/time.

CO1 is an arbitrarily predetermined constant. |X| is a function that represents the magnitude of X, and it is typically an absolute value. The example described here adopts the function g expressed as g(x)=CO1/|x| when f₁(metadata 1, metadata 2)=g(diff(rec_date(metadata 1)−rec_date(metadata 2))), but an applicable function is not limited thereto.

For example, the function g may use a norm L2 such as g(x)=CO1/∥x∥. Typically, ∥x∥ represents a square root of the sum of squared differences of elements that constitute x.

Further, g(x) may be a sigmoid function or a gamma function. In the above explanation, the function takes a larger value as the metadata 1 and the metadata 2 are closer to each other, but the function is not limited thereto. In particular, the function may take a smaller value as the two values are closer to each other. In addition, the function g may take a large value under a specific condition.

The function of f₂ may take a larger value as the title character strings of the metadata 1 and the metadata 2 share more character strings. For example, when the title of the metadata 1 is “ABCDE”, and the title of the metadata 2 is “FGCDH”, two letters “CD” are included in both titles. In contrast, when the metadata 1 is “ABCDE”, and the title of the metadata 2 is “FGHIE”, one letter “E” is included in both titles. Then, the former has a larger value for f₂.

In the above description, the numbers of characters included in the titles are compared to find the value for the function f₂, but an applicable function is not limited thereto. For example, the function may take a larger value when more letters are shared by the initial portions of the titles. The function may be established in such a manner that character strings having the same notion are regarded as shared character strings. For example, “baseball” and “ball game” may be regarded as character strings of the same notion. If the titles that are compared include either of these character strings, the function may judge that common character strings are included.

If the character strings of the main titles and the subtitles included in the two titles are compared to find that only the characters of the subtitles differ from each other, the function f₂ may take a larger value than in any other case. This is because the contents are often of the same series when the character strings of their main titles match and the character strings of their subtitles differ. For example, “ABCDE #2” and “ABCDE #3” can be regarded as different episodes of the same drama content. In such a situation, f₂ may be configured to output twice as large value as others.

The above description is a mere example, and a more advanced comparison may be conducted by use of a fuzzy search or regular expression search technique.

The function f₃ takes, for example, a large value when the metadata 1 and the metadata 2 have the same broadcast channel. For example, the function may be such that, when the broadcast channels are the same, a value CO2 is output, and a value 0 is output otherwise. Here, CO2 is a predetermined arbitrary constant.

As a further extension of the above, a function that outputs a different value when the channels are of the same broadcast group may be adopted. For example, when the broadcast channels of the metadata 1 and the metadata 2 are “NHK 1” and “NHK Educational”, respectively, which are of the same broadcast group and are both terrestrial broadcasting media, the function f₃ may be configured to return CO2/2.

Because “NHK 1 (terrestrial broadcasting)” and “NHK BS Hi-Vision (BS broadcasting)” are of the same broadcast group but of different broadcasting media, the function f₃ may be established as a further extension to return CO2/4. The above method is a mere example, and any function may be adopted as long as it returns a relevance value of channels.

The function f₄ takes a large value when, for example, the metadata 1 and the metadata 2 are in the same genre. For example, when the genres of the metadata 1 and the metadata 2 match, the function outputs a predetermined constant CO3, while when the genres do not match, the function outputs a value 0. Furthermore, the function may calculate the relevance in accordance with a hierarchical relationship between the genres. For example, when the genre of the metadata 1 is “sports” and the genre of the metadata 2 is “baseball”, “baseball” can be determined as a subordinate genre (subgenre) of “sports”. Thus, CO3/2 may be output as the relevance. Furthermore, when the genre of the metadata 1 is “baseball” and the genre of the metadata 2 is “soccer”, both of the upper genres (parent genres) of “baseball” and “soccer” are determined as “sports”. Thus, CO3/4 may be output as the relevance. The above method is a mere example, and any function that returns a relevance value of genres can be adopted.

The function f₅ outputs, for example, a larger value as the cast lists of the metadata 1 and the metadata 2 share more people. For example, the function f₅ may output (the number of cast members in common)×CO4. CO4 represents an arbitrary constant that is predetermined. For example, the cast lists of the metadata 1 and the metadata 2 are “WW, XX, YY” and “XX, YY, ZZ”, respectively, which means two people are in common. Then, the function f₅ outputs 2×CO4. If the cast lists of the metadata 1 and the metadata 2 are “VV, WW, XX” and “XX, YY, ZZ”, respectively, only one person is in common. Then, the function f₅ outputs 1×CO4. When there is no person in common, the function f₅ outputs 0.

A cast list may include not only individuals but also a group of several individuals. For this reason, when, for example, a cast member S belongs to group XX, and the cast lists of the metadata 1 and the metadata 2 are “VV, WW, XX” and “S, YY, ZZ”, the function f₅ may output CO4/2. This is because the cast list of the metadata 1 does not include the cast member S but includes the group XX to which S belongs, and therefore it can be regarded that S appears in the content.

In a similar manner, the function f₅ may be extended to output CO4/4 when a specific relationship is defined among groups or individuals that appear in the contents, such as group XX and group YY from the same agency. The relationship of the individuals (or groups) may be defined in the metadata, stored in advance in the content storage unit 121, or obtained from an external information site.

The function may calculate the relevance that is weighted in accordance with the order in the cast list. For example, when a match is established with the k-th individual listed in the metadata 1, the function may calculate the relevance with 1/k as a weighting constant. In other words, when a match is established with the first individual listed in the metadata 1, the calculated relevance is output as it is. When a match is established with the second individual listed in the metadata 1, the relevance multiplied by ½ is output. When a match is established with the third individual listed in the metadata 1, the relevance multiplied by ⅓ is output.

Furthermore, the relevance may be calculated by taking the listing orders of both the metadata 1 and the metadata 2 into account. For example, when the second individual of the metadata 1 and the third individual of the metadata 2 match, the relevance multiplied by ⅙=½×⅓ is output.

Moreover, metadata indicating that a cast member is the leading performer may be used to calculate the relevance. For example, when the matched cast member is the leading performer, the relevance multiplied by 2 is output. In this manner, the weight assigned to the relevance regarding the leading performer can be changed.

The relevance can be calculated in accordance with the above functions f₁ to f₅ and Expression (1). The above functions are mere examples, and any conventional function that represents the correlation between two values can be adopted.

For example, the relevance may be calculated from the correlation between histograms obtained for certain information on images. More specifically, a histogram of an image for any frame of the calculation target content 1 and a histogram of an image for any frame of the calculation target content 2 are calculated, and the relevance can be obtained by multiplying the degree of correlation between the two histograms by a weight. To obtain the histograms, any conventionally used information such as the brightness of images can be adopted.

In addition, the relevance is not limited to the calculation result obtained by a single method. For example, the results of relevance calculation obtained by multiple methods may be combined into a weighted linear sum, using weights that are defined by the user's designation or a preset profile.

The display content selecting unit 105 selects a target display content that is to be displayed on the display device 200, with reference to the history information stored in the selection history storage unit 122 and the relevance calculated by the relevance calculating unit 104.

More specifically, the display content selecting unit 105 first selects a history content of which the history information is stored in the selection history storage unit 122, as a display content. The display content selecting unit 105 selects, together with the process target content, at least a history content selected immediately before the process target content as a display content. In this manner, the user is allowed to select the preceding content from the displayed contents and return to the preceding content.

Furthermore, the display content selecting unit 105 selects a content for which the relevance calculated by the relevance calculating unit 104 satisfies a specific selection condition, as a display content. The display content selecting unit 105 uses a selection condition that contents are selected in decreasing order of their relevance, where the number of contents to be selected is determined by subtracting the number of already selected history contents from the maximum number of displayed contents. The selection condition is not limited thereto, however. For example, contents having relevance greater than a predetermined threshold may be selected as display contents.

The output information generating unit 106 generates output information to display the selected display contents on the display device 200. More specifically, the output information generating unit 106 generates multiple items of selection information by individually rendering the display contents into a selectable manner on the display device 200, and thereby generates the output information by arranging and displaying the items of selection information in accordance with certain patterns. In the output information generated by the output information generating unit 106, the selection information of contents having greater relevance to the process target content is arranged closer to the selection information of the process target content. In this manner, the user can accurately judge the relevance of the contents and select a desired content.

The output information generating unit 106 includes, as smaller structural components, a display content arranging unit 106a and a space rendering unit 106b.

The display content arranging unit 106a arranges and renders the selected display contents in a specific area by use of the metadata acquired by the second metadata acquiring unit 103.

As illustrated in FIG. 4, the display content arranging unit 106a overlays a content representing image 401, a program title 402, a recording date/time 403, and a broadcast channel 404 on a rectangular background 400 and thereby renders a display content. These information elements are acquired by the second metadata acquiring unit 103.

In the following example, the elements (metadata) that are to be rendered include the background 400, the content representing image 401, the program title 402, the recording date/time 403, and the broadcast channel 404 as illustrated in the drawing. Elements that are to be rendered are not limited thereto, however. The layout of the elements is also not limited to the one illustrated in the drawing.

The display content arranging unit 106a renders the elements that are laid out as illustrated in FIG. 4, by use of computer graphics (CG) technology, for example. In particular, the display content arranging unit 106a first prepares a plate-shaped polygon that suits the display size of the background 400. Then, the display content arranging unit 106a performs texture-mapping of the content representing image 401 onto part of the surface (or on the entire surface) of the polygon so that the layout as indicated in FIG. 4 can be achieved.

As for character information elements such as the program title 402, the recording date/time 403, and the broadcast channel 404, the display content arranging unit 106a first renders these character information elements, and generates the rendered images as texture images. Then, the display content arranging unit 106a performs the texture-mapping of the generated texture images onto predetermined positions in predetermined sizes (on part of the surface of the polygon).

Various methods have been offered to render the character information. For example, a technology of rendering character data that is expressed by vector data in texture data by use of CG shader technique may be adopted to realize the rendering.

The character rendering method that is explained above is a mere example. Thus, the method is not limited thereto, but any conventional method can be adopted. The background 400 may be painted in a predetermined color, or a predetermined image may be applied to the background 400 by texture mapping. The background 400 may be changed in accordance with the metadata. For example, by referring to the genre of the metadata, the background 400 may be painted in blue when the genre of the content is “sports”, while the background 400 may be painted in yellow when the genre is “drama”.

In this manner, the display content arranging unit 106a visually expresses the metadata acquired from the content storage unit 121 and thereby renders the display content. In the above example, the user can check the genre, title, recording date/time, broadcast channel, and image of the content by viewing the rendered display content. In the following description, the display content that is rendered is referred to as “rendered content”.

The rendered contents can be selected by the user when they are displayed on the display device 200. In other words, the user selects any of the displayed rendered contents to designate the next process target content. Thus, the rendered contents correspond to the above selection information.

Furthermore, the display content arranging unit 106a arranges, in a specific area, multiple rendered contents obtained by rendering the selected display contents.

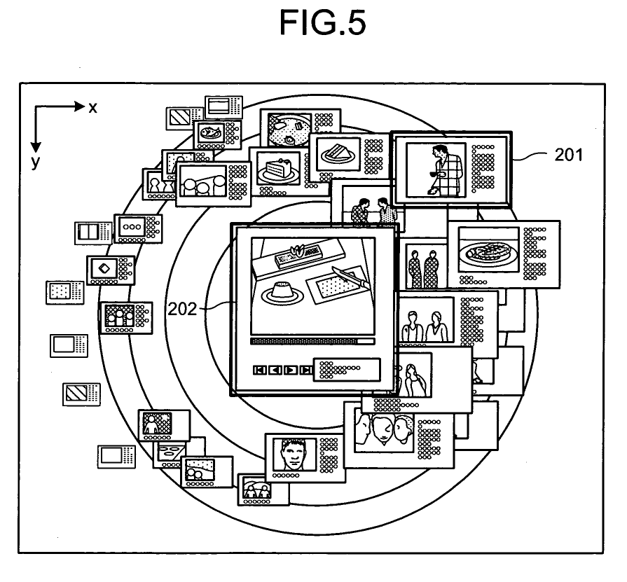

As illustrated in FIG. 5, rendered contents including a rendered content 201 and a rendered content 202 are arranged in a three-dimensional space. In this drawing, the three-dimensional space having a group of rendered contents is viewed from the above (from a distance in the positive direction of the z-axis).

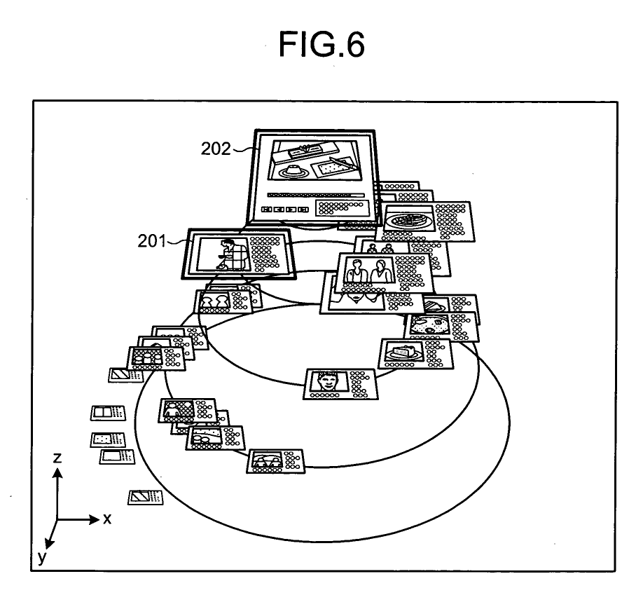

The display content arranging unit 106a arranges the rendered contents in the three-dimensional space in a three-dimensional manner. For this reason, when the three-dimensional space is viewed from a different direction, the rendered contents in the same arrangement can be observed in a different style. FIG. 6 is a diagram of the same group of rendered contents arranged in the same three-dimensional space as FIG. 5 but viewed from a different point (from the front of the space, i.e. from a distance in the positive direction of the y-axis slightly toward the positive direction of the z-axis).

The process performed by the display content arranging unit 106a for arranging the display contents in accordance with the relevance will be described in detail later.

The space rendering unit 106b renders the space that includes the group of rendered contents generated and arranged by the display content arranging unit 106a, in accordance with predetermined viewpoint conditions. First, the space rendering unit 106b sets up space rendering parameters. More specifically, the space rendering unit 106b determines from which direction the space should be rendered. From the aspect of CG, the space rendering unit 106b sets up parameters for the camera position (viewpoint), direction, and scope to render the space.

The space rendering unit 106b also sets up parameters for the position, intensity, and coverage of the light source to render the space, if necessary. Furthermore, the space rendering unit 106b determines the rendering range and method. Various methods can be adopted for a method of determining the rendering method. For example, first, several different rendering methods are defined by use of a shader program. Then, the space rendering unit 106b determines a rendering method from the defined rendering methods by referring to the user's input, system setup values, or the like. Then, the space rendering unit 106b implements a shader program that defines the determined rendering method on a GPU (Graphics Processing Unit), which is hardware specially designed for graphics processing.

After setting up the parameters for the space rendering in this manner, the space rendering unit 106b renders the space. More specifically, the space rendering unit 106b renders the CG space in accordance with the set-up CG parameters. In this manner, the display content arranging unit 106a renders the group of rendered contents arranged in the three-dimensional space.

With a CG technology called shadow volume generation, for example, when the rendered contents are overlapping each other, a shadow of the front content may be cast on the content in the back. In this case, a light should be placed in front of the contents on which the shadow is cast, and a shadow is attached by the shadow volume technique.

The same effect can be achieved by executing image processing on the images after the rendering as a post effect. The space rendering unit 106b also renders information other than the display contents. For example, when the display contents are sorted according to genres and rendered on the corresponding coordinate axes on the side surface of a conical table as described later, the coordinate axes representing the genres, the genre names, isosurfaces of the cone are rendered altogether, and superimposed on the rendered contents.

Post-effect image processing may be further performed on the images that are rendered in the above manner. An additional rendering process may be performed on the obtained rendered image by use of a different shader program to obtain a new rendered image.

By the process of the space rendering unit 106b, an image of the group of rendered contents viewed from a specific viewpoint is generated as output information.

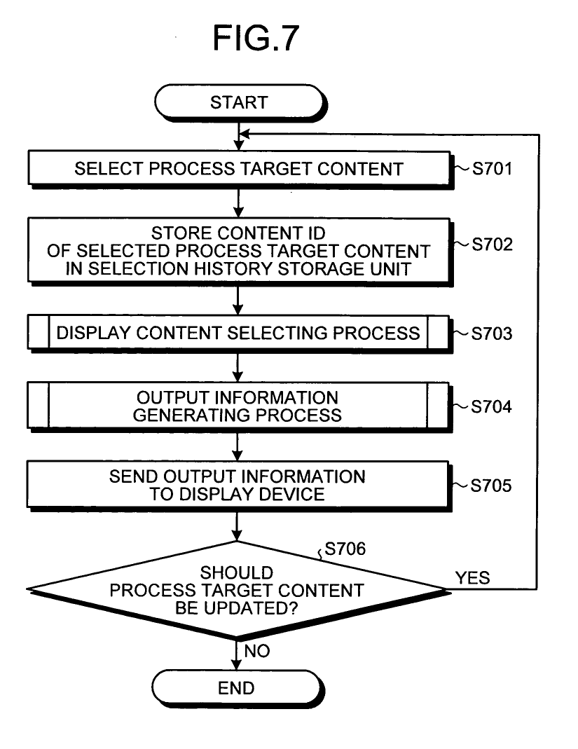

Next, the image processing performed by the image processing apparatus 100 that is configured according to the first embodiment is explained below with reference to FIG. 7.

First, the target content selecting unit 101 selects a content as a process target content from the content storage unit 121 (Step S701). As a process target content, the target content selecting unit 101 selects, for example, the content that is being viewed. The last view content, last recorded content, or a content selected with reference to the user's profile may also be selected as a process target content. Moreover, a content designated by the user with a mouse or a remote controller from a list of recorded contents that are rendered by the GUI of the display device 200 may be selected as a process target content. Furthermore, when the content is being viewed and the user presses down a predetermined button of the remote controller, the content now being viewed may be selected as a process target content.

Next, the target content selecting unit 101 stores the content ID of the selected process target content in the selection history storage unit 122 (Step S702).

Then, a display content selecting process is executed to select the selected process target content and contents relevant to the process target content as display contents (Step S703). Thereafter, an output information generating process is executed to generate the output information for displaying the selected display contents on the display device 200 (Step S704). The display content selecting process and the output information generating process will be discussed in detail later.

Next, the output information generating unit 106 outputs the generated output information to the display device 200 (Step S705). As a result, the process target content, a group of contents highly relevant to the process target content, and the history content of which the history information is stored in the selection history storage unit 122 that are arranged in the space according to the relevance are displayed on the display screen of the display device 200.

Then, the target content selecting unit 101 determines whether the process target content should be updated (Step S706). For example, the target content selecting unit 101 determines whether a predetermined length of time has been elapsed if a selection condition that a content with the greatest relevance to the current process target content is selected as the next process target content at intervals of the predetermined length is adopted. The target content selecting unit 101 may be configured to determine whether the user has selected a content other than the process target content from the contents selected on the display screen of the display device 200.

When the process target content needs to be updated (Yes at Step S706), the target content selecting unit 101 selects a new process target content in accordance with the selection condition (Step S701), and repeats the process. When the process target content does not need to be updated (No at Step S706), the image processing is terminated.

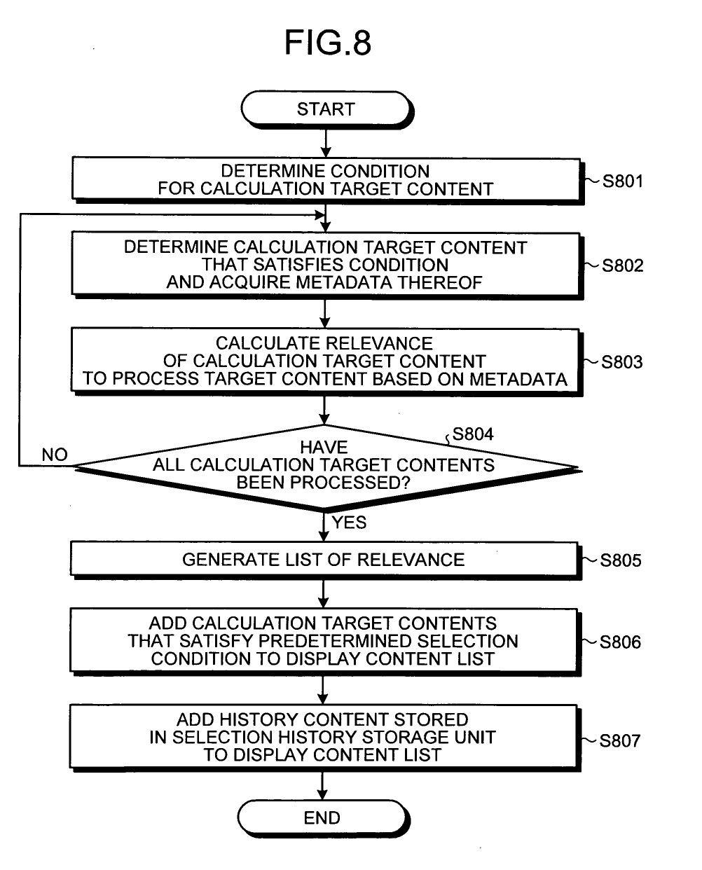

Next, the display content selecting process at Step S703 is explained in detail with reference to FIG. 8.

First, the relevance calculating unit 104 determines the condition for a calculation target content (the calculation target content 2 in the above description), which is a target content of relevance calculation as a content relevant to the process target content (Step S801). For example, the relevance calculating unit 104 determines a condition that all the contents included in the content storage unit 121 are selected as calculation target contents.

The condition of the calculation target contents may be changed by prior setting. For example, the metadata may be designed so that the category or value of the metadata used as a condition can be set up and that conditions can be changed in accordance with the setting. For example, the conditions may be changed among a condition of targeting at contents recorded after a specific date/time, a condition of targeting at contents of a specific genre, and a condition of targeting at contents including a specific title. The condition of the calculation target contents may be provided by the user's input, or predetermined as system setting. The relevance calculating unit 104 adds the history contents to the calculation target contents under any condition.

Next, the relevance calculating unit 104 selects a single calculation target content that satisfies the determined condition and has not been subjected to the relevance calculation (Step S802). The relevance calculating unit 104 acquires the metadata of the process target content (metadata 1) from the content storage unit 121 by use of the first metadata acquiring unit 102. In addition, the relevance calculating unit 104 acquires the metadata of the calculation target content (metadata 2) from the content storage unit 121 by use of the second metadata acquiring unit 103.

Next, the relevance calculating unit 104 calculates the relevance of the calculation target content to the process target content, based on the acquired metadata 1 and metadata 2 (Step S803).

Next, the relevance calculating unit 104 determines whether the relevance to the process target content has been calculated for all the calculation target contents (Step S804). When the relevance has not been calculated for all the calculation target contents (No at Step S804), the next unprocessed calculation target content is selected to repeat the process (Step S802).

When the relevance has been calculated for all the calculation target contents (Yes at Step S804), the relevance calculating unit 104 generates and outputs a list of calculated relevance (Step S805).

Next, the display content selecting unit 105 selects, as display contents, calculation target contents other than the history content that meet a predetermined selection condition by referring to the generated relevance list, and adds the selected contents to a display content list (Step S806). The display content list denotes a list that holds the selected display contents.

For example, when the maximum number of contents acquired from the system setting or the user's input is N, and the number of calculation target contents for which the relevance has been calculated exceeds N, the display content selecting unit 105 selects the number N−M (where M is the number of history contents) of calculation target contents in decreasing order of relevance and adds them to the display content list. The display content selecting unit 105 may sort and store the display contents in the display content list in decreasing order of relevance.

Next, the display content selecting unit 105 adds the history content to the display content list and updates the display content list (Step S807). As a result, the number N of contents including the history content are listed up in the display content list. Because the process target content is also stored as a history content in the selection history storage unit 122 at Step S702 of FIG. 7, the process target content is added to the display content list.

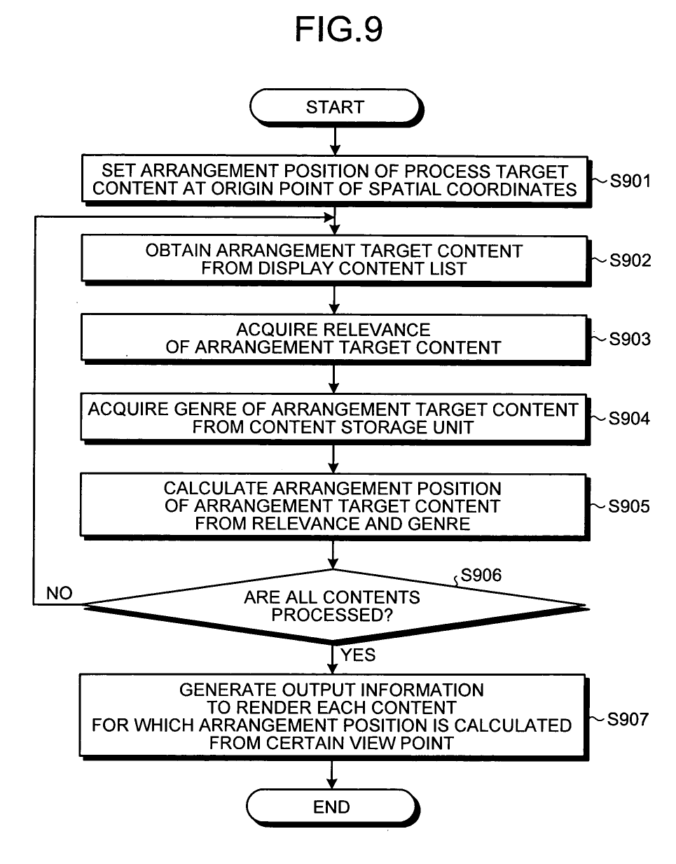

Next, the output information generating process performed at Step S704 is explained with reference to FIG. 9.

First in the output information generating process, the display content arranging unit 106a arranges the contents included in the display content list in the three-dimensional space and renders them (Steps S901 to S906).

More specifically, first, the display content arranging unit 106a sets the position of the process target content at the origin point of the three-dimensional space (Step S901). As discussed above, the process target content is a content that is selected by the target content selecting unit 101 and serves as a reference for the relevance calculation. Thus, the display content arranging unit 106a arranges the process target content rendered as illustrated in FIG. 4, at the origin point of the three-dimensional space, (x, y)=(0,0). In the arrangement of this rendered content, the display content arranging unit 106a determines the direction of the normal of the rendered content as the direction of the z-axis, or in other words normal vector=(0, 0, 1).

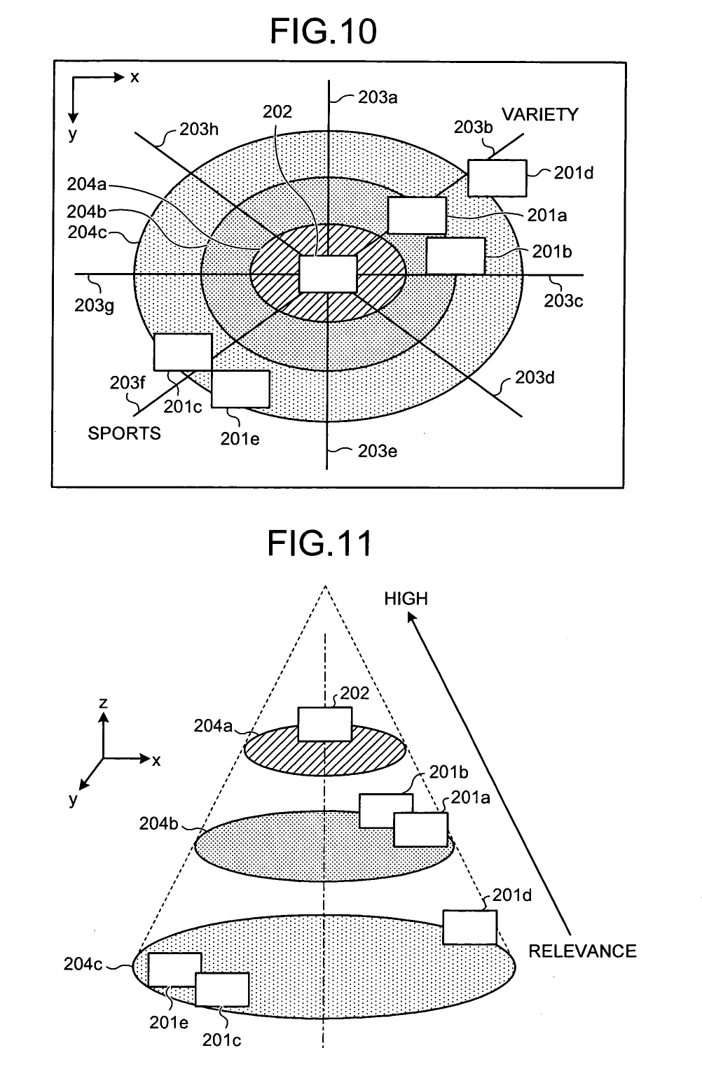

FIG. 10 is a diagram for illustrating an example arrangement of the target three-dimensional space when it is viewed from the top. FIG. 11 is a diagram for illustrating an example arrangement of the target three-dimensional space when it is viewed from the front. The rendered content 202 in the two drawings corresponds to the process target content that is rendered and arranged at the origin point at Step S901.

Next, the display content arranging unit 106a obtains an unprocessed content that is to be arranged, from the display content list (Step S902). For example, the display content arranging unit 106a selects a content with the greatest relevance from the yet-to-be-arranged contents. The display content arranging unit 106a generates a rendered content laid out as illustrated in FIG. 4 from the acquired content. In the following description, the content that is acquired from the display content list and rendered is referred to as an arrangement target content.

Then, the display content arranging unit 106a acquires the relevance of the acquired arrangement target content (Step S903). The relevance has been calculated in the display selecting process.

Thereafter, the display content arranging unit 106a acquires a genre from the metadata of the arrangement target content stored in the content storage unit 121 by use of the second metadata acquiring unit 103 (Step S904). The acquired genre is used to determine the direction for arranging the arrangement target content, as described later. The acquired metadata is not limited to the genre, but more than one category of the metadata can be acquired to determine the arrangement position.

Then, the display content arranging unit 106a calculates the arrangement position of the arrangement target content in accordance with the relevance and the genre (Step S905). In particular, the display content arranging unit 106a calculates the arrangement position by the following procedure.

First, as illustrated in FIG. 10, the radial directions on the x-y plane of the rendered content 202 of the process target content arranged at the origin point are assigned to the genres of the metadata acquired at Step S904. In this drawing, the radial area is divided into eight azimuths, i.e. azimuths 203a to 203h. A genre is assigned in advance to any one of the divided eight azimuths. In the drawing, “variety” is assigned to the azimuth 203b, and “sports” is assigned to the azimuth 203f.

The above method of assigning genres is a mere example, and it is not limited thereto. Furthermore, any metadata categories other than the genre can be assigned to the azimuths. The assignment does not have to be fixed, and may be configured to dynamically change in accordance with viewing conditions and the like. For example, by referring to the history of the user's previous operations, the genres of the most frequently viewed programs may be assigned to the azimuths 203a, 203b, . . . , 203h in descending order. The assigning method may be changed in accordance with the user's input. Different categories of the metadata may be assigned to different azimuths. For example, genres may be assigned to the azimuths 203a and 203b, while the recording date/time may be assigned to the azimuth 203c so that several different categories of metadata can be assigned at a time.

Then, the display content arranging unit 106a virtually establishes a conical table as illustrated in FIG. 11. More specifically, the display content arranging unit 106a arranges the rendered content 202 of the process target content on an upper base plane 204a of the conical table. In the established conical table, it is assumed that the radius of the upper base plane 204a is a constant r1 and that a lowermost base plane 204c (of a radius r2) is provided at a negative position with respect to the z-axis. A plane 204b in this drawing indicates a middle plane between the upper base plane 204a and the lowermost base plane 204c.

Then, the display content arranging unit 106a arranges axes corresponding to the above azimuths on the side surface of the conical table. The position of the arrangement target content is determined in such a manner that a greater z value on these axes represents greater relevance and a smaller z value represents smaller relevance.

Once the parameters for the upper base plane 204a and the lowermost base plane 204c are determined and a method of converting the relevance to the z value is defined, the position on the conical table corresponding to a specific relevance can be uniquely determined by solving a simple geometrical equation. The parameters of the conical table may be predetermined or suitably modified in accordance with the user's history or input.

The method of converting the relevance to a z value should also be predetermined. For example, a conversion equation such as z=A×(maximum relevance value−relevance of arrangement target content) can be adopted. In this equation, “A” is any constant. The conversion equation is not limited thereto, and any conversion equation by which a z value can be obtained from a certain relevance value can be adopted.

The z value may be obtained from the relevance by a conversion equation that is not a continuous function. For example, a conversion equation such as z=round (A×(maximum relevance value−relevance of arrangement target content)) may be incorporated. In this equation, “round” represents a function that rounds off decimals. Then, the same relevance may be output for different relevance values. The above conversion equations may be suitably adopted in accordance with the user's history or input.

With the above process, the height of the conical table (z value) in the side view is determined from the relevance, and the azimuth at the determined height is determined from the genre. Thus, when the relevance is v1 and the genre is “variety”, for example, the position of this arrangement target content is calculated and determined as a position corresponding to the rendered content 201a in FIGS. 10 and 11. When the relevance is v2 (<v1), and the genre is “sports”, the position of this arrangement target content is calculated and determined as a position corresponding to the rendered content 201c in FIGS. 10 and 11. An example arrangement of the rendered contents 201a to 201e is shown in FIGS. 10 and 11.

By calculating the arrangement positions in this manner, when the three-dimensional space is viewed from the above as illustrated in FIG. 10, it can be easily understood that the rendered content 201a and the rendered content 201c are different in genre. When the three-dimensional space is viewed from the side as illustrated in FIG. 11, it can be easily understood that the relevance of the rendered content 201a is greater than that of the rendered content 201c.

In FIG. 9, the display content arranging unit 106a determines whether all the contents in the display content list are processed (Step S906). When not all the contents are processed (No at Step S906), the display content arranging unit 106a acquires the next unprocessed content and repeats the process (Step S902).

When all the contents are processed (Yes at Step S906), the space rendering unit 106b generates output information in which the rendered contents arranged in the three-dimensional space are rendered from a certain view point (Step S907).

With the above process, for example, the process target content rendered in the center of FIGS. 10 and 11, as well as a group of contents rendered around the center, including the contents in the content storage unit 121 that are highly relevant to the process target content and the history contents that serve as process target contents before (201a to 201e in the drawings), can be displayed on the display screen of the display device 200.

As a result, the relevance of a group of contents stored in the database (content storage unit 121) to a moving image (process target content) can be rendered. Then, the user learns the distribution of contents relevant to this moving image. At the same time, because the contents that are previously selected by the user and stored as the search history (history contents) are arranged on the same screen in such a manner that they are recognizable at a glance, the user is allowed to return to the content that is selected immediately before.

In the above explanation, the display contents are rendered in the three-dimensional space as images including the content representing images as indicated in FIG. 4. The rendering method is not limited thereto, and any method with which contents with greater relevance are displayed closer to the process target content can be adopted. For example, the contents may be rendered in a two-dimensional space. Alternatively, identification information, such as titles, with which the display contents can be identified, may be output in the form of a list. The output information of the list form may be generated in such a manner that the process target content is arranged at the very top, and the contents having relevance thereto are arranged in decreasing order of the relevance.

The image processing apparatus according to the first embodiment generates, by storing the history of selected contents and referring to the stored history, output information in which previously selected contents are always selected and displayed as contents relevant to a selected content. Hence, the user is allowed to return to the content that is selected immediately before and suitably select contents relevant to sequentially selected contents.

A modification example of the first embodiment is now explained. In this modification example, the following function is added to the space rendering unit 106b according to the first embodiment.

In particular, the space rendering unit according to the modification example is provided with a function of performing an image effect process on rendered contents of history contents so that the user can recognize them as history contents. The space rendering unit according to the modification example further performs a process of connecting the history contents by predetermined CG objects so that the user can recognize the order in which the target content selecting unit 101 selects the contents.

More specifically, the space rendering unit according to the modification example performs a CG process so that a rendered content generated from the history content can be recognized as a previously selected process target content among the rendered contents. For example, the space rendering unit according to the modification example performs image processing to render the content in a sepia tone and give it the feel of faded color as it looks like an aged photograph. Any conventional method can be adopted for the sepia-tone image processing.

When more than one history content is present, the color difference (Cb and Cr in the Y-Cb-Cr color system) may be adjusted in the sepia-tone conversion in such a manner that the fading feel can be intensified as the time elapsed since the contents are selected become longer. An applicable image processing is not limited thereto. Other image processing methods may be combined or any one of them may be solely adopted. For example, the contrast may be intensified as time elapsed since a history content is stored becomes longer.

Moreover, among the rendered contents generated and arranged by the display content arranging unit 106a, the space rendering unit according to the modification example renders the rendered contents of the history contents, by generating objects such as straight lines, ovals, and chains that suggest the connections of the history contents between the history contents. More specifically, the space rendering unit according to the modification example generates the objects in the reverse chronological order starting from the latest history content and connects the history contents. For example, when a history content A, a history content B, and a history content C are stored in this order in the selection history storage unit 122, the objects are generated between the history content A and the history content B, and then between the history content B and the history content C. The space rendering unit according to the modification example renders the generated objects together with other rendered contents.

The space rendering unit according to the modification example determines, for example, the center of gravity of the rendered content corresponding to each history content, and generates an object between the centers of gravity of the rendered contents corresponding to two consecutive history contents in the order of being stored in the selection history storage unit 122.

When a straight line is generated as an object, the line should be positioned in such a manner that the two ends of the line match the positions of the centers of gravity. When an oval is generated as an object, the two ends of the major axis of the oval should match the positions of the centers of gravity. When a chain is generated as an object, the centers of gravity should be included inside the ovals at the ends of the chain. Whether the centers of gravity are included in the ovals can be judged in accordance with a conventional method.

The positions connecting the rendered contents are not limited to the centers of gravity. For example, any of the vertices of CG models representing the rendered contents may be connected together, or any points on the edge lines of the CG models may be connected together. Furthermore, the generated objects are not limited to lines, ovals, and chains. Any object that can uniquely determine the positions connecting the contents, or any object from which whether an area contained by the object includes the positions connecting the contents can be judged, can be adopted.

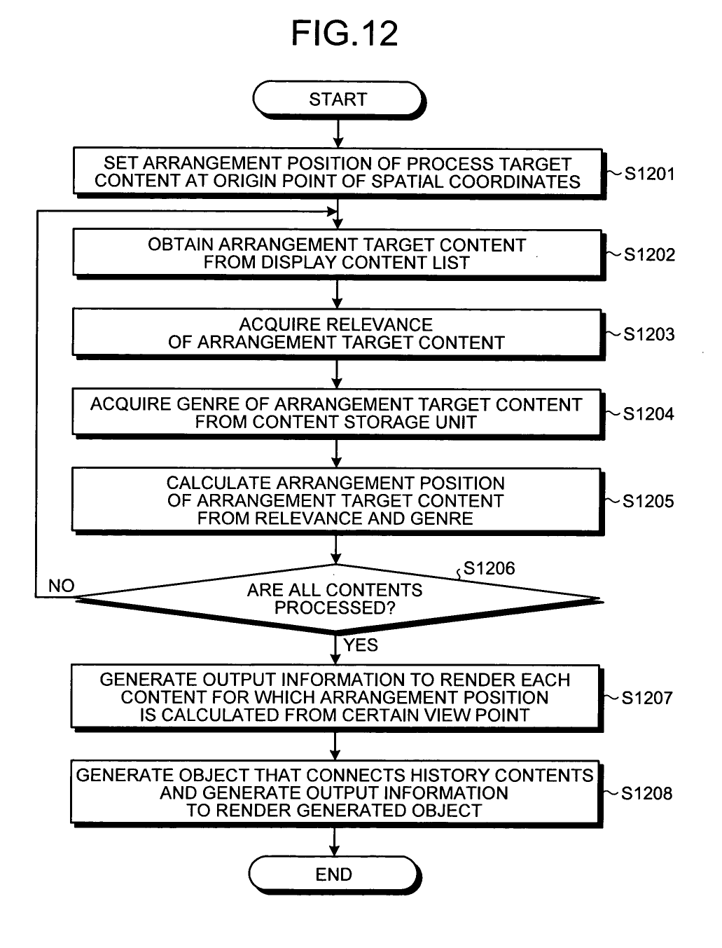

The output information generating process according to the modification example is explained in detail below with reference to FIG. 12. The procedure of the processing other than this process is the same as FIGS. 7 and 8 according to the first embodiment, and thus the explanation thereof is omitted.

The output information generating process indicated in FIG. 12 is different from the output information generating process indicated in FIG. 9 according to the first embodiment in that Step S1208 at which objects are generated and rendered is added. The rest of the procedure is the same as FIG. 9, and thus the explanation is omitted.

At Step S1208, the space rendering unit according to the modification example generates objects such as straight lines that connect the history contents, and generates the output information to render the generated objects.

According to this modification example, the effect processing can be added so that the relevance of the history contents to the current process target content becomes clearly recognizable at a glance. Thus, the user can intuitively recognize the field of search performed by the user oneself, such as which genre is mainly being searched for or which genre is not in search. Even when the history contents are arranged in an order different from the search order (such as the relevance), the search order can be intuitively recognized.

An image processing apparatus according to a second embodiment allows the user to select a desired content from a group of contents displayed on the display device, and, when the selected content is a previously selected history content, the device generates and renders objects that connect history contents in a similar manner to the above modification example.

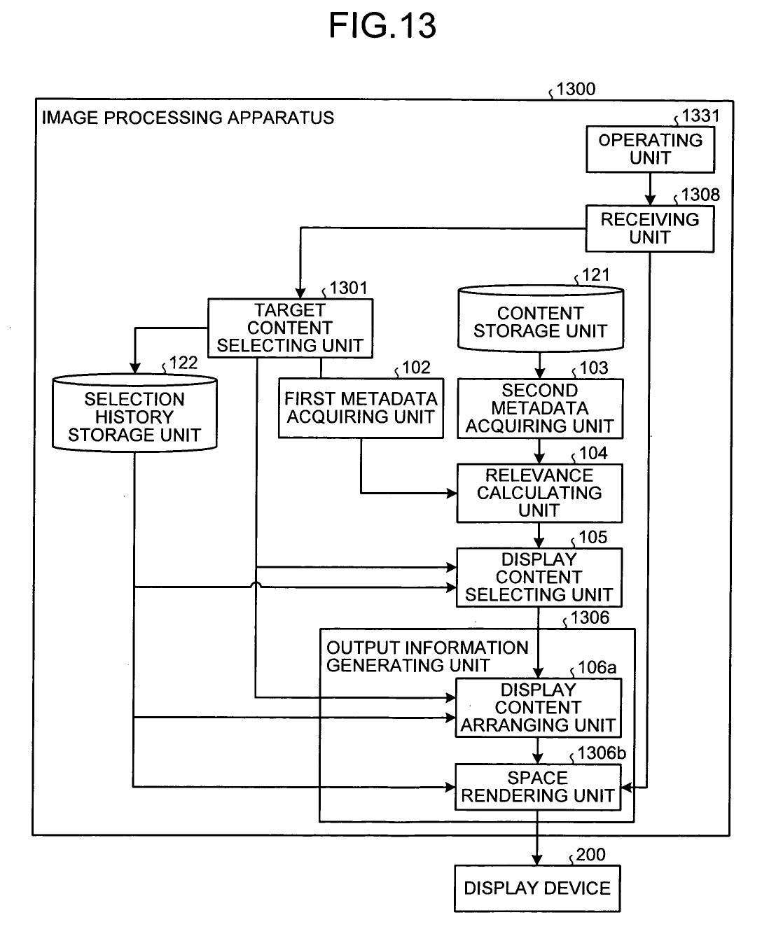

As illustrated in FIG. 13, an image processing apparatus 1300 includes the content storage unit 121, the selection history storage unit 122, a target content selecting unit 1301, the first metadata acquiring unit 102, the second metadata acquiring unit 103, the relevance calculating unit 104, the display content selecting unit 105, an output information generating unit 1306, an operating unit 1331, and a receiving unit 1308.

The second embodiment is different from the first embodiment in that the operating unit 1331 and the receiving unit 1308 are added, and that the functions of the target content selecting unit 1301 and a space rendering unit 1306b of the output information generating unit 1306 are changed. The rest of the structure and functions is the same as the block diagram of FIG. 1 showing the structure of the image processing apparatus 100 according to the first embodiment. Thus, the same components are given the same numerals, and the explanation thereof is omitted.

The operating unit 1331 is a mouse or a remote controller that is operated by the user, and outputs the positional information designated on the display screen of the display device 200. In the following description, a mouse is adopted for the operating unit 1331. The user may operate the mouse with reference to the mouse cursor displayed on the screen of the display device 200, for example.

The receiving unit 1308 receives the positional information output by the operating unit 1331. The receiving unit 1308 also transmits the received positional information to the space rendering unit 1306b, and issues an instruction to the space rendering unit 1306b to display the mouse curser at a position corresponding to the positional information.

In addition, the receiving unit 1308 identifies the rendered content that is positioned under the current mouse position (mouse cursor position) by use of information on the arrangement positions of the rendered contents obtained from the display content arranging unit 106a and rendering view-point information obtained from the space rendering unit 1306b.

More specifically, the receiving unit 1308 uses ray tracing from the mouse cursor position (coordinate position of the mouse in the screen space) toward the direction of the view-point vector in the rendered three-dimensional space to find the rendered content closest to the view point among the rendered contents crossed by the rays. To find such a rendered content, the receiving unit 1308 performs simple geometrical operations on all the rendered contents for which the three-dimensional intersection points with the three-dimensional straight lines can be viewed from the view point.

Furthermore, the receiving unit 1308 issues an instruction to the space rendering unit 1306b to render the rendered content that is found in the above manner to be positioned beneath the mouse cursor position, in a different style.

When the user performs a certain determination operation such as pressing of the left click button of the mouse, the receiving unit 1308 notifies the target content selecting unit 1301 that the rendered content that is found to be positioned under the mouse cursor position is selected as a new process target content.

The target content selecting unit 1301 selects the content notified of by the receiving unit 1308 as the process target content. This makes the target content selecting unit 1301 different from the target content selecting unit 101 according to the first embodiment.

In response to the instruction received from the receiving unit 1308 of displaying the mouse cursor at the position of the mouse, the space rendering unit 1306b renders the mouse cursor by superimposing it at the corresponding position of the rendering result.

Furthermore, when the rendered content notified of by the receiving unit 1308 is a history content, the space rendering unit 1306b generates and renders objects that show the connections of the history contents. The method of generating the objects is the same as the modification example of the first embodiment.

However, objects do not have to be generated for all the history contents stored in the selection history storage unit 122. For example, objects may be generated between the history content notified of by the receiving unit 1308 and one history content stored before and one history content stored after this history content. Objects may be generated between the history content notified of by the receiving unit 1308 and any history contents older than this history content. Alternately, objects may be generated between the history content notified of by the receiving unit 1308 and history contents stored more recently than this history content.

The image processing apparatus according to the second embodiment renders the connection of the history contents only when the user focuses on a certain history content. Thus, even when the contents are arranged in an order different from the search order (such as relevance), the user can intuitively recognize the search order, without losing the visibility of the display results.

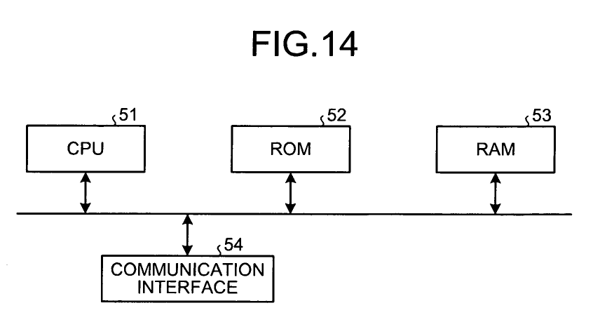

Next, the hardware structure of the image processing apparatus according to the first and second embodiments is explained with reference to FIG. 14.

The image processing apparatus according to the first and second embodiments includes a control device such as a CPU 51, storage devices such as a ROM 52 and a RAM 53, a communication interface 54 for being connected to a network to perform communications, external storage devices such as an HDD and a CD drive, a display device, input devices such as a keyboard and a mouse, and a bus 61 for connecting these units. A regular computer is used for the hardware structure.

A computer program product executed by the image processing apparatus according to the first and second embodiments is recorded and offered in a computer readable recording medium such as a CD-ROM, a flexible disk, a CD-R, and a DVD in an installable or executable format.

A computer program product for the image processing according to the first and second embodiments may be recorded in advance in a ROM or the like.

A computer program product executed by the image processing apparatus according to the first and second embodiments has a module structure including the above units (the target content selecting unit, the first metadata acquiring unit, the second metadata acquiring unit, the relevance calculating unit, the display content selecting unit, and the output information generating unit). As actual hardware, the CPU 51 reads the image processing program from the recording medium and executes it so that each unit is loaded and generated on the main storage device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
an image storage unit that stores a plurality of images and metadata of the images;
a first selecting unit that sequentially selects a first image, which is any one of the images stored in the image storage unit;
a selection history storage unit that stores history information capable of identifying images selected by the first selecting unit past and an order in which the images are selected;
a relevance calculating unit that calculates a relevance representing how relevant the first image is to the images other than the first image, based on metadata of the first image and metadata of images stored in the image storage unit other than the first image;
a second selecting unit that selects, based on the history information, second images representing at least an image selected immediately before the first image and an image that satisfies a first selection condition predetermined in relation to the relevance; and
a generating unit that generates output information, which is information for displaying, on a display device, first selection information capable of selecting the first image and second selection information capable of selecting any of the second images, the second selection information of the second images having greater relevance being displayed closer to the first selection information.

2. The apparatus according to claim 1, wherein the generating unit generates, as the output information, an output image that is used for displaying a first selection image capable of selecting the first image and second selection images capable of selecting any of the second images on the display device, the second selection images of the second images having the greater relevance being arranged closer to the first selection image.

3. The apparatus according to claim 2, wherein the generating unit generates the output image including an image of an object that connects the first selection image and a second selection image of the second image identified by the history information from among the second images.

4. The apparatus according to claim 3, further comprising a receiving unit that receives a second selection image selected by the user from among the second selection images displayed on the display device, wherein
the first selecting unit further selects, as a new first image, a second image corresponding to the received second selection image; and
the generating unit judges whether the first image can be identified by the history information, and generates the output image including the image of the object when the first image can be identified by the history information.

5. The apparatus according to claim 2, wherein
the images are moving images including a plurality of still images; and
the generating unit generates the output image to display, on the display device, the first selection image that is any one of still images included in the first image and the second selection images that are any of still images included in the second images.

6. The apparatus according to claim 1, wherein the generating unit generates the output information in such a manner that the second selection information of the second image identified by the history information is displayed in a displaying manner different from the second selection information of the second images other than the second image identified by the history information.

7. The apparatus according to claim 1, further comprising a receiving unit that receives second selection information selected by the user from among the second selection information displayed on the display device, wherein
the first selecting unit further selects a second image corresponding to the received second selection information, as a new first image.

8. The apparatus according to claim 1, wherein the first selecting unit selects an image having metadata that satisfies a predetermined second selection condition as the first image, from among the images stored in the image storage unit.

9. The apparatus according to claim 1, wherein the relevance calculating unit calculates the relevance of the first image to images other than the first image, with respect to images that satisfies a predetermined third selection condition among images stored in the image storage unit other than the first image.

10. The apparatus according to claim 1, wherein
the metadata includes identification information for identifying the images; and
the generating unit generates the output information that is used for displaying first identification information that is identification information of the first image as the first selection information and second identification information that is identification information of the second images as the second selection information on the display device, the second identification information of second images having greater relevance being displayed closer to the first identification information.

11. An image processing method comprising:
sequentially selecting from a plurality of images stored in an image storage unit that stores the images and metadata of the images, a first image that is any one of the images;
storing in a selection history storage unit history information capable of identifying the images which are selected past and an order in which the images are selected;
calculating a relevance representing how relevant the first image is to the images other than the first image, based on metadata of the first image and metadata of images other than the first image among the images stored in the image storage unit;
selecting, based on the history information, second images representing at least an image selected immediately before the first image and an image that satisfies a first selection condition predetermined in relation to the relevance; and
generating output information, which is information for displaying, on a display device, first selection information capable of selecting the first image and second selection information capable of selecting any of the second images, the second selection information of second images having greater relevance being displayed closer to the first selection information.

12. A computer program product having a computer readable medium including programmed instructions for processing images, wherein the instructions, when executed by a computer, cause the computer to perform:
sequentially selecting from a plurality of images stored in an image storage unit that stores the images and metadata of the images, a first image that is any one of the images;
storing in a selection history storage unit history information capable of identifying the images which are selected past and an order in which the images are selected;
calculating a relevance representing how relevant the first image is to the images other than the first image, based on metadata of the first image and metadata of images other than the first image among the images stored in the image storage unit;
selecting, based on the history information, second images representing at least an image selected immediately before the first image and an image that satisfies a first selection condition predetermined in relation to the relevance; and
generating output information, which is information for displaying, on a display device, first selection information capable of selecting the first image and second selection information capable of selecting any of the second images, the second selection information of second images having greater relevance being displayed closer to the first selection information.
